(19) United States
(12) Patent Application Publication
(10) Pub. No.: US 2010/0027491 A1
(43) Pub. Date: Feb. 4, 2010

(54) UPLINK RESOURCE CONTROL

(75) Inventors: Guy REINA, Givataim (IL); Danny STOPLER, Holon (IL)

Correspondence Address: MARTIN D. MOYNIHAN d/b/a PRTSI, INC., P.O. BOX 16446, ARLINGTON, VA, 22215, US

(73) Assignee: Alvarion Ltd., Tel-Aviv (IL)

(21) Appl. No.: 12/511,178

(22) Filed: Jul. 29, 2009

Related U.S. Application Data
(60) Provisional application No. 61/084,307, filed on Jul. 29, 2008.

(51) Int. Cl. H04W 72/04; H04W 52/00; H04B 17/00

(52) U.S. Cl. 370/329; 455/452.1; 455/522; 370/311; 455/67.13

(57) ABSTRACT

Apparatus for interference budgeting at base stations of a wireless network wherein mobile units communicate with a current base station but may cause interference to neighboring base stations, comprises: an extraction unit for extracting, from signals received at said current base station in relation to respective mobile units, an interference indication; and an uplink management unit for controlling the uplink to mobile units, wherein said management unit is connected to said extraction unit to obtain respective interference indications, thereby to use said respective interference indications as constraints when allocating said uplink resources. The resource may be uplink power or an uplink frequency channel that is allocated to different mobile stations and/or it may be interference budget that is allocated between base stations.

### RELATIONSHIP TO EXISTING APPLICATIONS

The present application claims benefit under 35 U.S.C. §119(e) from U.S. Provisional Patent Application No. 61/084,307 filed Jul. 29, 2008, the contents of which are incorporated herein by reference.

### FIELD AND BACKGROUND OF THE INVENTION

The present invention, in some embodiments thereof, relates to a cellular communication system and, more particularly, but not exclusively, to uplink power control and even more particularly, but not exclusively, to uplink resource control.

The invention belongs to the field of cellular communication and particularly to the field of uplink power control in the 802.16e, or WiMAX system. The invention may also be applicable to OFDMA multi-carrier systems 802.16 such as 16e and 16m LTE 3GPP 802.22, 802.20, Next generation PHF. The WiMAX system comprises mobile stations MS, circulating amongst a network of base stations BS. Each MS participating in the network is connected to a current BS via an uplink UL-MS to BS and a downlink DL BS to MS. Currently UL power control is based on the path loss between the MS and the serving BS. The target of the power control in this case is to ensure that the MS unit transmission is received by the BS with sufficient power to enable correct decoding. The power control process disregards the level of interference caused to other base stations as a result of the subscriber transmission

Current scheduling and UL power control schemes are based only on path loss to the serving base stations, ignoring interference to other base stations as a parameter.

However, ignoring interference to other base stations reduces deployment capacity.

Additionally, interference with neighboring base stations is strongly dependent on the location of the mobile station with respect to the neighboring base station. A mobile station that is equidistant from two base stations may cause considerable interference with the equally distant base station it is not communicating with. On the other hand a mobile station that is much closer to its own base station may interfere very little with neighboring base stations. Thus the setting of a fixed maximum power level to avoid interference is very wasteful for those mobile stations not currently in interference-causing locations. Keeping each mobile station as quiet as possible provides an unnecessary limitation on the data rate that can be provided, and thus artificially and unnecessarily limits the power of wireless systems to provide broadband.

### SUMMARY OF THE INVENTION

The present embodiments provide an ongoing measurement of interference levels involving individual mobile stations and use that to optimize resources so that interference is minimized. Mobile stations typically report a carrier-to-interference and noise ratio, CINR, which indicates downlink experienced interference, and the present embodiments assume symmetry of the channels so that this can be used as an indication of uplink caused interference. The base stations then use the reports to provide quantification measures or constraints for allocating the resources, although the way in which allocation is carried out may well occur at the mobile stations.

According to an aspect of some embodiments of the present invention there is provided an apparatus for interference budgeting at base stations of a wireless network wherein mobile units communicate with a current base station yet may cause interference to neighboring base stations, comprising:

an extraction unit for extracting, from signals received at said current base station in relation to respective mobile units, an interference indication;

an uplink management unit for controlling the uplink from mobile units, wherein said management unit is connected to said extraction unit to obtain respective interference indications, thereby to use said respective interference indications as constraints when allocating said uplink resources.

In an embodiment, said uplink management unit is a power management unit and said allocating uplink resources comprises allocating power to individual mobile stations.

In an embodiment, said uplink management unit is a frequency management unit and said allocating uplink resources comprises allocating frequency channels to individual mobile stations.

In an embodiment, said uplink management unit is an interference budget management unit and said allocating uplink resources comprises allocating interference budget between respective base stations.

In an embodiment, said extraction unit is configured to obtain a signal to interference ratio from a respective mobile unit.

In an embodiment, said extraction unit is configured to extract said interference indication from handover signaling relating to said neighboring base stations.

In an embodiment, said extraction unit is configured to obtain a signal to interference ratio from a respective mobile unit as a relatively high rate interference indication, and to extract an additional interference indication from handover signaling relating to said neighboring base stations when available to use as a relatively low frequency correction to said relatively high rate indication.

In an embodiment, said signal to interference ratio comprises a carrier to interference ratio.

In an embodiment, said power management unit is configured to apply power preferentially to units associated with lower interference indications.

In an embodiment, said wireless network is a network configured such that neighboring base stations use substantially similar power levels, thereby allowing reciprocity of interference to hold between said base stations.

In an embodiment, said power management unit is configured to reassign frequencies to mobile stations using total interference as a constraint.

According to a second aspect of the present invention there is provided a method for managing resource allocation for uplinks to mobile units at base stations of a network, comprising:

extracting, from signals received at respective base stations of said network in relation to respective mobile units, an interference indication; and

controlling uplink resources to mobile units using respective interference indications, thereby to use said respective interference indications as constraints when allocating said uplink resources.

According to a third aspect of the present invention there is provided a method for managing resource allocation for uplinks to mobile units at base stations of a network, comprising:

obtaining interference measures of respective mobile units, said obtained measures relating to experienced downlink interference;

controlling uplink resources to said respective mobile units to minimize uplink interference to surrounding base stations, said minimizing being based on said obtained measures.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram showing a base station modified in accordance with an embodiment of the present invention;

FIG. 2 is a simplified diagram showing areas of interference between a complex of three base stations;

FIG. 3 is a simplified schematic diagram illustrating the allocation of power as the resource, between mobile stations, according to an embodiment of the present invention;

FIG. 4 is a simplified diagram illustrating the allocation of frequency channels as the resource, between mobile stations, according to an embodiment of the present invention; and

FIG. 5 is a simplified diagram illustrating the allocation of interference budget as the resource, between base stations, according to an embodiment of the present invention.

### DESCRIPTION OF EMBODIMENTS OF THE INVENTION

The present invention, in some embodiments thereof, relates to uplink resource control and, more particularly, but not exclusively, to uplink power control

For convenience and ease of explanation, many of the embodiments discussed in this disclosure are described in terms of their application in a WiMAX network. The use of WiMAX, terminology should not be construed as limiting the invention to embodiments within those domains. Rather the invention's applicability to any managed wireless network will be evident to one trained in the art and the use of the example terminology is only to aid the reader in understanding various aspects of the invention.

As explained, the present embodiments provide an ongoing measurement of interference levels involving individual mobile stations and that ongoing measurement is utilized to optimize resources so that interference is minimized, which allows an increase in deployment capacity or total available resource. Mobile stations typically report a carrier to interference and noise ratio, CINR, which indicates downlink experienced interference, and the present embodiments assume symmetry of the channels so that this can be used as an indication of uplink caused interference.

For each base station a budget is set up of maximum interference levels that may be caused to the neighbors. Alternatively optimization is provided between interference and resources. That is to say a balance is obtained between interference and resource availability to maximize throughput.

The budget can be either a total budget for the base station or may be handled as separate budgets for each neighboring base station.

The interference may be estimated using downlink CINR reports, which are received with high frequency from the individual mobile stations. However these can only be used to estimate total interference levels, and do not relate to specific neighboring base stations or indeed to base stations at all.

As an alternative, handover scanning reports may be used. These reports are provided when the base stations scan the interference, amongst other parameters, when considering handing over a mobile station between base stations. The information is less frequently generated than the CNIR reports but is specific to the causes of the interference.

Handling of the interference budget using dynamically measured interference according to the present embodiments may lead to selection of transmission modes that reduce interference level, and increase total capacity.

As an example, whereas in the prior art, standard frame building practices prefer to allocate one sub-channel of QAM 16½ (where ½ indicates the rate of the error correction code), an interference aware frame building according to the present embodiments may understand that the limiting factor is not bandwidth but interference level and instead prefer the allocation of two sub-channels of QPSK ½.

In the following, state of the art scheduling schemes such as proportional fair scheduling make use of the interference measurements at individual MSs to increase capacity by giving precedence to users who cause low interference.

Additionally, opportunistic scheduling can be used to schedule users at times where they cause minimal interference, again reducing the interference level per set service.

The system may automatically adapt to either high CINR low interference scenarios as in fixed broadband wireless access, BWA, or high interference scenarios as per mobile broadband wireless access.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

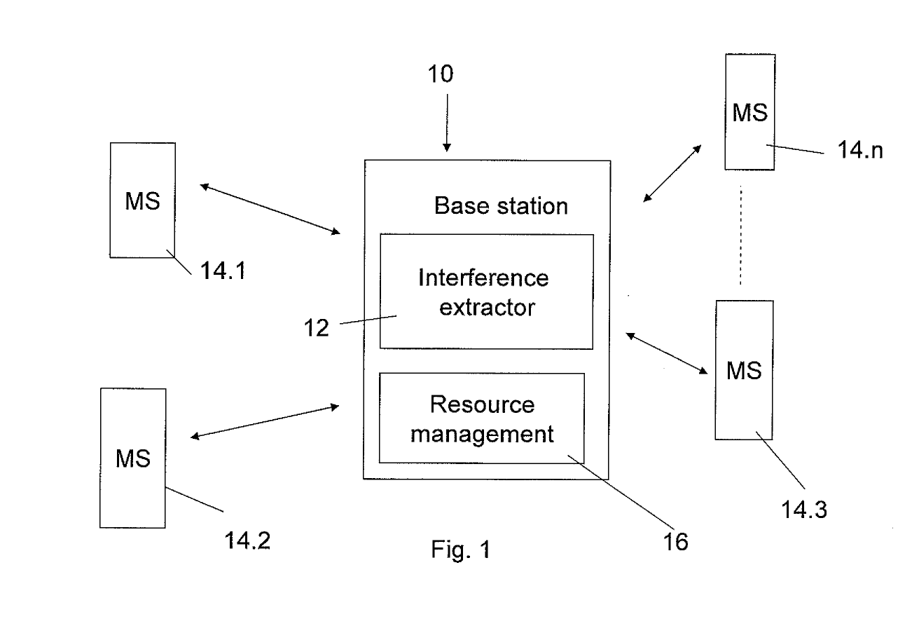

Referring now to the drawings, FIG. 1 illustrates apparatus for interference budgeting, or optimization, say at a base station of a wireless network, wherein mobile units communicate with a current base station but may cause interference to neighboring base stations.

Base station 10 comprises an extraction unit 12 for extracting interference indications from signals received at the base station in relation to the different mobile stations 14.1 . . . 14.n in communication with the base station 10. As will be explained below, the interference indicator 12 may be an actual value transmitted by the mobile station. Additionally or alternatively the interference indicator may derive from inter-base station signaling regarding the mobile unit. In cases where the mobile station does not report a value, an indicator may be derived at the base station from a signal transmitted by the mobile station, or, as will be explained below, or any other suitable indicator may be used.

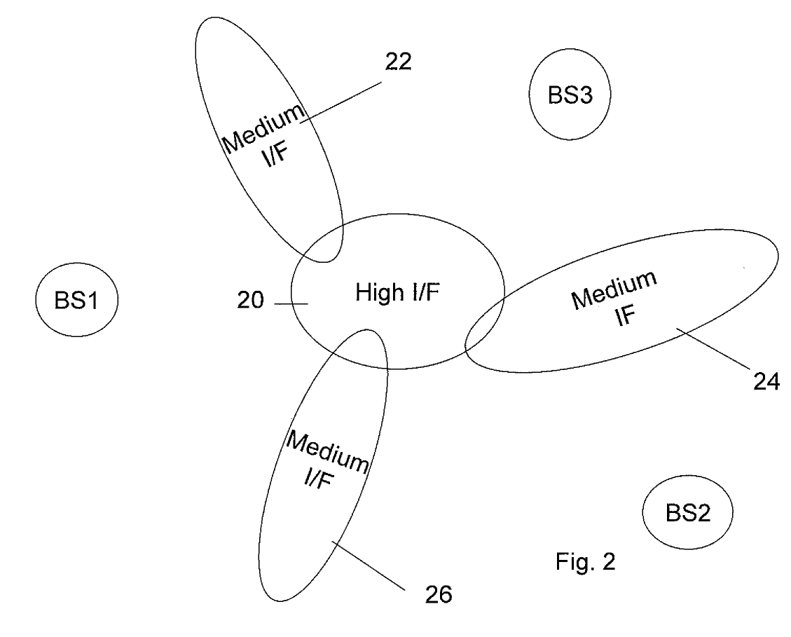

A resource management unit 16, which may be an uplink management unit controls a resource, such as uplink power, to the mobile units 14.1 . . . 14.n. The power management unit 16 obtains the interference indications from the extraction unit 12 for the different mobile stations and uses the interference indications as constraints for allocating resources, for example when allocating uplink power. Referring now to FIG. 2 a complex of three base stations is shown, BS1, BS2 and BS3. A region of high interference 20 forms in the region where signals from all three base stations are of approximately equal strength. Three regions of medium interference 22, 24 and 26 are formed in regions where interference from two of the three base stations are of approximately equal strength. It will be appreciated that uplink power assigned to mobile stations in any of the regions marked will bring about interference concerns in respect of neighboring base stations. On the other hand, higher levels of power can be allocated to mobile stations clearly outside of these regions without there being too much fear of interference with the neighboring base stations.

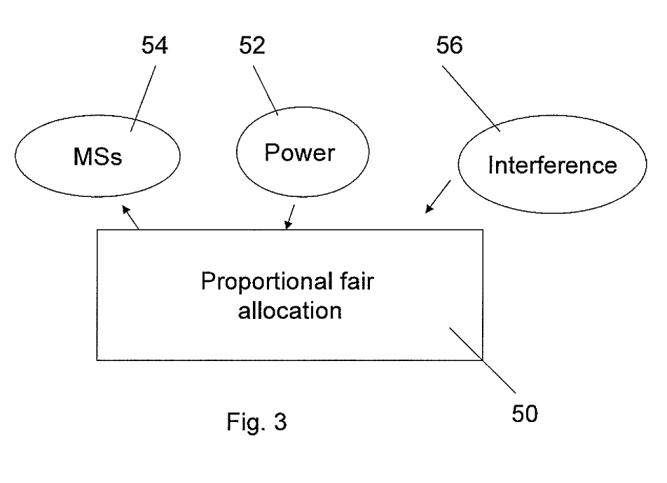

Referring now to FIG. 3, which shows a proportional fair allocation unit 50 according to an embodiment of the present invention and indicates the variables that it senses and controls. The allocation unit 50 allocates power 52 or other resources amongst a series of mobile stations 54 in such a way as to ensure that the total interference 56 caused to neighboring base stations is kept within an interference budget. Alternatively the allocation unit 50 may allocate the power or like resource 52 in such a way as to optimize between the available resources and resulting interference in order to maximize throughput. In one embodiment, the allocation unit may attempt to find a way to allocate more resources to mobile stations experiencing little interference, thus giving higher total allocated resources for minimal additional interference.

Proportional fair allocation is a compromise-based scheduling algorithm, which may be used by the allocation unit 50. The algorithms are generally based upon maintaining a balance between two competing interests. In one embodiment there may in fact be three interests as follows:

1) trying to maximize total wireless network utilization while

2) at the same time allowing all users at least a minimal level of service, and

3) ensuring that interference to neighbors does not exceed a predetermined interference budget.

Typical algorithms may achieve this by assigning each data flow a data rate or a scheduling priority (depending on the implementation) that is inversely proportional to its anticipated resource consumption, the resource consumption in this case being interference.

Proportionally fair scheduling can be achieved by means of weighted fair queuing (WFQ), by setting the scheduling weights for data flow i to wᵢ=1/cᵢ, where the cost cᵢ is the amount of consumed resources per data bit. For instance in wireless networks of the kind described above the cost may simply be the interference as measured for the given mobile station.

In one embodiment, a scheduler acts in a round-robin fashion and serves all mobile stations but not equally often. Rather the stations are served in inverse proportion to their resource consumption—in this case interference consumption. Depending on the setting of coefficients the scheduler will always provide the best service to the mobile station with the best interference conditions. This will maximize the throughput of the channel while stations with high interference are served less, and in the extreme are not served at all.

In a first embodiment, the parameter used to obtain the interference is the carrier-interference and noise ratio CINR. It is noted that the CINR is neither the carrier to noise ratio (CNR) nor the carrier to interference ratio (CIR) but is a hybrid of the two, as follows:

The carrier-to-interference ratio (C/I, CIR), is the quotient between the average received modulated carrier power S or C and the average received co-channel interference power I, i.e. cross-talk, from other transmitters than the useful signal.

The CIR resembles the carrier-to-noise ratio (CNR or C/N), which is the signal-to-noise ratio (SNR or S/N) of a modulated signal before demodulation.

The CIR ratio is studied in interference limited systems, i.e. where I dominates over N, typically in cellular radio systems and broadcasting systems where frequency channels are reused in order to achieve high level of area coverage. The C/N is studied in noise limited systems. If both situations can occur, as in the present case, the carrier-to-noise-and-interference ratio, C/(N+I) or CINR may be studied.

The CINR may be derived at the individual mobile stations and reported to the base station. If not reported then the CINR may be derived by the base station when receiving signals from the mobile station. The CINR is consistently available and allows a dynamic picture of interference to be drawn for real time modification of the constellation. The CINR in fact measures the interference experienced by the mobile station in the downlink—that is back to the base station, not the interference that it causes in the uplink, but an assumption of symmetry is made, namely that the interference caused is equivalent to the interference experienced, and the uplink is equivalent to the downlink. As described above the CINR includes both the interference and the noise while we actually looking for the interference element. As we are focusing on users that cause large interference levels, we will assume that the CINR is a good estimation of the CIR.

An alternative way of obtaining the interference data is by deriving an interference indication from handover signaling relating to the neighboring base stations. Each mobile station that approaches the boundary between two base stations is considered for handover between the base stations, and considerations used in handover include interference. So the interference data made available at handover may be used. Handover data has the advantage that it is measured between two base stations so that the results are absolute and do not involve any assumptions. However data is not available at all times and so dynamic compensation for suddenly arising circumstances is not possible.

A third embodiment uses a combination of the above two systems. CINR is measured in the short term to provide real time measurements for fast adaptation of the system. Then handover data is used when available to calibrate the CINR.

The embodiments are now considered in greater detail. A first embodiment is based on using the reported downlink CINR as an estimate of the ratio between the desired signal (signal level received at the serving BS) and the total outgoing interference signal (signal level received by the non-serving base-stations).

In one embodiment the total outgoing interference level estimation is used as the basis for interference budget management. For interference budget management, the RRM, or radio resource management for example at the base station, allocates power to the mobile stations based on both a total outgoing interference budget from the current base station to all other base stations and the required power that the mobile station needs for correct reception at the serving base station.

In the third embodiment referred to above, by using the handoff scanning information in addition to CINR, it is possible to estimate interference from the desired base station which is incoming to any other base station, as this is reported by the handoff scanning. In this embodiment the RRM, radio resource management, allocates power to the mobile stations based on

1) a budget of total allowed incoming interference from the current base station to any other base stations and

2) the required power for correct reception at the serving base station.

The first embodiment, which controls total outgoing interference, is appropriate for deployments where users are uniformly distributed, however it would fail when a hot spot occurs in and around a single cell. The third embodiment, which controls incoming interference to any base station, can handle any type of user distribution.

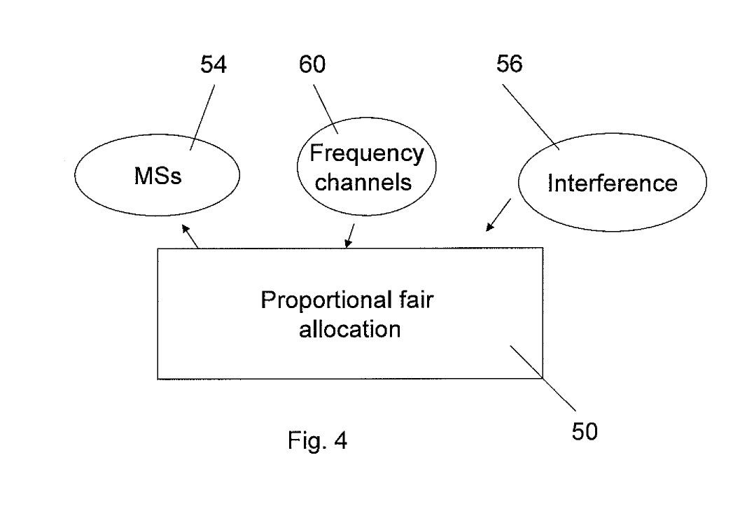

Reference is now made to FIG. 4, which is a simplified schematic diagram illustrating a fourth embodiment of the present invention. As with FIG. 3, a proportional fair allocation unit 50 allocates resources between mobile stations 54. In this case interference 56 is optimized or budgeted against allocation of frequency channels. In general MSs are not allocated full channels but rather are allocated time slots on particular frequency channels.

In the fourth embodiment it is possible to further exploit incoming interference measurements, or even estimates if measurements are not available, by doing just in time frequency planning. That is to say mobile stations 54 are allocated with different frequency channels 60 based on the measured interference 56. Those amongst mobile stations 54 which are in regions of higher interference are allocated to frequencies not currently in use by the neighboring base station or not especially likely to interfere with frequencies in use by the neighboring base station. That is to say, instead of setting the power of the transmission so as to minimize interference, the system sets the frequency of the system so as to minimize interference. The setting may be based on the same interference metrics used in the previous embodiments.

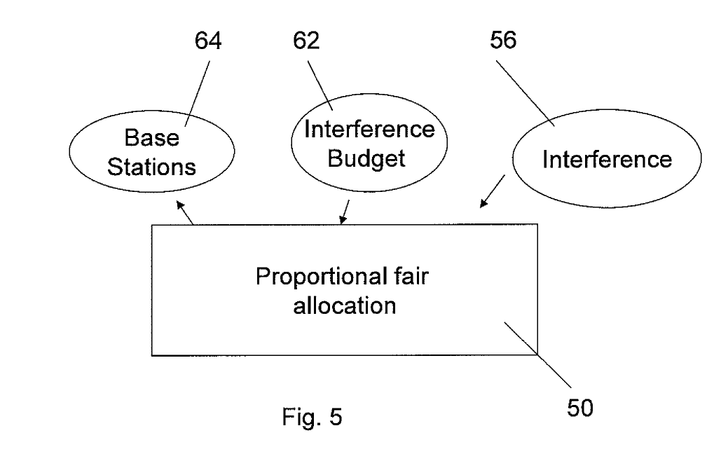

Reference is now made to FIG. 5, which shows a fifth embodiment of the present invention, in which interference budget 62 is allocated between base stations 64. Each base station is set with a certain interference budget but may not be using all of the budget all of the time. Budget may therefore be allocated to other base stations which are currently short of budget, using the same or different allocation algorithms. Then for example within the base station itself the interference budget is allocated between the mobile stations as per the previous embodiments.

That is to say the fifth embodiment comprises a deployment level interference coordination between base stations. Allocation algorithms allocate uplink (UL) interference budget from one base station to any other base station. In this case the same allocation algorithms as described hereinabove may be used for dynamic allocation of unused interference budget between the base stations of the network.

The present embodiments are useful in any uplink power control scheme for WiMAX cellular deployment, since WiMAX does not provide other means for fast interference based power control. The present embodiments provide tools for efficient handling of broadband mobile deployment, market, while enabling performance optimization in a high CINR environment, such as the fixed broadband wireless access, BWA, traditional markets.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. Apparatus for maximizing capacity of a wireless network wherein mobile units communicate with a serving base station, comprising:
an extraction unit for extracting an interference indication in relation to respective mobile units; and
an uplink management unit for controlling the uplink from mobile units, wherein said management unit is connected to said extraction unit to obtain respective interference indications, thereby to use said respective interference indications as constraints when allocating said uplink resources, thereby achieving said maximizing capacity.

2. The apparatus of claim 1, wherein said maximizing capacity of said controlling by said uplink management unit comprises maximization of resources under interference constraints.

3. Apparatus according to claim 1, wherein said uplink management unit is a power management unit and said allocating uplink resources comprises allocating power to individual mobile stations.

4. Apparatus according to claim 1, wherein said uplink management unit is a frequency management unit and said allocating uplink resources comprises allocating frequency channels to individual mobile stations.

5. Apparatus according to claim 1, wherein said uplink management unit is an interference budget management unit and said allocating uplink resources comprises allocating interference budget between respective base stations.

6. Apparatus according to claim 1, wherein said uplink management unit comprises a slot allocation unit for allocating slots, said slots respectively comprising defined combinations of resources.

7. Apparatus according to claim 6, wherein said defined combinations of resources comprise frequency-time-modulation or frequency-time-power or modulation-power, or modulation-time-power combinations.

8. Apparatus according to claim 1, wherein said extraction unit is configured to obtain a signal to interference ratio from a respective mobile unit.

9. Apparatus according to claim 1, wherein said extraction unit is configured to extract said interference indication from handover signaling relating to said neighboring base stations.

10. Apparatus according to claim 1, wherein said extraction unit is configured to obtain a signal to interference ratio from a respective mobile unit as a relatively high rate interference indication, and to extract an additional interference indication from handover signaling relating to said neighboring base stations when available to use as a relatively low frequency correction to said relatively high rate indication.

11. Apparatus according to claim 1, wherein said signal to interference and noise ratio comprises a carrier to interference and noise ratio.

12. Apparatus according to claim 1, wherein said uplink management unit is configured to apply resources preferentially to units associated with lower interference indications.

13. Apparatus according to claim 1, wherein said wireless network is a network configured such that neighboring base stations use substantially similar power levels, thereby allowing reciprocity of interference to hold between said base stations.

14. Apparatus according to claim 1 wherein said uplink management unit is configured to reassign resources to mobile stations using total interference as a constraint.

15. A method for managing resource allocation for uplinks to mobile units from base stations of a network, comprising:
extracting interference indications at said network in relation to respective mobile units; and
controlling uplink resources from mobile units using respective interference indications, thereby to use said respective interference indications as constraints when allocating said uplink resources.

16. A method for managing resource allocation for uplinks to mobile units at base stations of a network, comprising:
obtaining interference measures of respective mobile units, said obtained measures relating to experienced downlink interference; and
controlling uplink resources to said respective mobile units to optimize resource allocation with uplink interference to surrounding base stations, said optimizing being based on said obtained measures.

17. The method according to claim 16 wherein said obtaining said interference measures comprises using downlink CINR reports.

18. The method according to claim 16 wherein said obtaining said interference measures comprises estimating said interference measures using handover scanning reports.

19. The method according to claim 16, wherein said controlling uplink resources comprises allocating power to individual mobile stations.

20. The method according to claim 16, wherein said controlling uplink resources comprises allocating frequency channels to individual mobile stations.

21. The method according to claim 16, wherein said controlling uplink resources comprises allocating interference budget between respective base stations.

22. Method according to claim 16, wherein said controlling uplink resources comprises a slot allocation unit for allocating slots, said slots respectively comprising defined combinations of resources.

23. Method according to claim 22, wherein said defined combinations of resources comprise frequency-time-modulation or frequency-time-power or modulation-power, or modulation-time-power combinations.

24. The method according to claim 16, comprising extracting said interference measures from handover signaling relating to said neighboring base stations.

25. Method according to claim 16, comprising obtaining a signal to interference and noise ratio from a respective mobile unit as a relatively high rate interference indication, and extracting an additional interference indication from handover signaling relating to said neighboring base stations when available to use as a relatively low frequency correction to said relatively high rate indication.

26. The method according to claim 16, comprising applying resources preferentially to units associated with lower interference indications.

27. The method according to claim 16, wherein said wireless network is a network configured such that neighboring base stations use substantially similar power levels, thereby allowing reciprocity of interference to hold between said base stations.

28. The method according to claim 16 comprising reassigning resources to mobile stations using total interference as a constraint.

29. The method of claim 28, wherein said resources consist of any member of the group comprising power, frequency, time, and modulation.
